(19) United States
(12) Patent Application Publication
(10) Pub. No.: US 2003/0177016 A1
(43) Pub. Date: Sep. 18, 2003

(54) Revenue recognition system and method for efficiently performing business-related processing and storing of event information related to a transaction

(75) Inventors: Richard Lowell Lawhorn JR., Peachtree City, GA (US); Carey David Stewart, Sharpsburg, GA (US); Scott Paul Gosline, Duluth, GA (US); Rodney Wayne Sculthorpe, Lilburn, GA (US)

Correspondence Address: KING & SPALDING, 191 PEACHTREE STREET, N.E., ATLANTA, GA, 30303-1763, US

(73) Assignee: Delta Air Lines, Inc., Atlanta, GA

(21) Appl. No.: 10/099,075

(22) Filed: Mar. 13, 2002

(51) Int. Cl. G06F 17/60

(52) U.S. Cl. 705/1

(57) ABSTRACT

In a system for recognizing revenue for the sale of services, where the amount of revenue recognized is based upon the use of the services and upon events that can occur before the services are used that can potentially affect the amount of revenue recognized for the sale, a master ticket record processor can receive and process information related to an event, which is associated with a sale of services and which occurs at some time after the sale. A business-related processor can perform additional business-related processing of the event information to derive a business result that can supplement the event information. The master ticket record processor can then store both the business result and the event information related to a sale in a storage device.

### TECHNICAL FIELD

The present invention relates to revenue recognition systems. More specifically, the present invention relates to a system and method for efficiently receiving and processing event information related to a transaction for which revenue cannot be recognized until a particular event occurs so that it is available for revenue recognition and business analysis.

### BACKGROUND OF THE INVENTION

In the retail industry, a sales transaction is complete upon the sale of the goods. Thus, a retailer recognizes revenue immediately upon the sale of the item. Systems that assist a retailer in calculating its recognition of sales revenue, therefore, calculate revenue immediately upon the sale of the good regardless of whether the purchaser subsequently exchanges the item or returns the item.

In contrast, in the travel, transportation, and airline industries, revenue is not recognized upon the sale of a ticket. Rather, revenue is only recognized once the ticket is used and the travel services that were purchased are fulfilled. Thus, revenue recognition systems in the conventional art that calculate revenue based upon when the item is sold (as opposed to when services are rendered and complete) cannot be used for the travel, transportation, or airline industry.

Additionally, conventional revenue recognition systems that calculate revenue based only upon the timing and the amount of the sale of the item cannot account for the multiple changes to a travel ticket that can occur after the sale of the ticket. For example, in the travel industry, often times after booking a ticket, passengers change a departure date or departure time to accommodate for changes in their travel plans. Sometimes these changes (or “events”) result in the payment of additional fees for the difference between a less expensive travel itinerary and a more expensive travel itinerary. In other words, these unpredictable events can affect the amount of revenue recognized by a travel service provider.

Therefore, conventional revenue recognition systems used by the travel industry today must collect and account for later itinerary changes made to a purchased ticket that could potentially affect revenue. Typically, such conventional revenue recognition systems used by the airline and travel industry are batch-only systems that collect and process such ticketing and event information from a plurality of sources as that information is received. The batch-only nature of such systems can result in significant lag times between the completion of the travel services rendered and when revenue can finally be calculated and recognized. In other words, because the event information related to a transaction is transmitted to the revenue recognition system a potentially significant amount of time after the transportation services are rendered, and because the batch systems do not process the event information as it is received, revenue can often not be recognized until a significant amount of time after the services are rendered. Thus, a transportation service provider is unable to make educated and effective business decisions relating to the amount of revenue recognized for certain flight legs, airlines, carriers, and travel destinations.

Moreover, because these legacy revenue recognition systems were developed prior to the concept of electronic ticketing, they struggle to keep-up with the advances of electronic ticketing. Though electronic ticketing has led to the transportation industry's ability to process electronic ticket and travel information more quickly, the legacy batch systems still require a substantial amount of time to process non-electronic information and do not perform intermediate processing of event information as it is received.

Consequently, there is a need in the art for efficiently performing the real-time (or near real-time) processing of event information related to a transaction for a faster accounting for allocation of revenue. Additionally, there is a need in the art for efficiently performing intermediate processing of information related to events that occur over time. Last, there is a need in the art to take full advantage of the characteristics of electronic ticketing data for efficient allocation of revenue for such ticketing events.

### SUMMARY OF THE INVENTION

The present invention can solve the aforementioned problems by providing a system and method for recognizing revenue arising from one or more sales transactions for which revenue is recognized at some point in time after the actual sales transaction and after which one or more events can occur that can affect the amount of revenue recognized. In other words, the system and method allows the efficient processing of event information related to a sales transaction that can affect the amount of revenue recognized for the sales transaction.

A master ticket record processor can process event information related to a particular transaction and store the information in a storage device, such as a data store or data mart. Additionally, upon receiving event information related to one or more pre-defined events, the master ticket record processor can route the event information to a business processor to derive a business result that will supplement the event information maintained in the data store.

The business processor can comprise a work flow manager, which can define (based upon the event) what type of business-related processing should be performed by one or more business services. Using the work routing slip, the business processor can route the event information to the business services identified in the work routing slip for processing. The one or more derived business results can then be stored by the master ticket record processor in the data store with the event information associated with the transaction.

Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a functional block diagram illustrating some components of a network for processing event information for a transaction in accordance with an exemplary embodiment of the present invention.

FIG. 2 is a logic flow diagram illustrating an exemplary embodiment of a process for processing events associated with a single transaction and that occur over time.

FIG. 3 is a functional block diagram illustrating an external data processor for an exemplary embodiment of the present invention.

FIG. 4 is a logic flow diagram illustrating an exemplary sub-process or routine of FIG. 2 for receiving event information from external data sources, and validating and storing that information in a data store.

FIG. 5 is a logic flow diagram illustrating an exemplary sub-process or routine of FIG. 2 for distributing ticket information from a ticket distributor to a master ticket record process.

FIG. 6 is a functional block diagram illustrating an exemplary embodiment of a master ticket record processor of the present invention for processing event information and storing the event information in a data store.

FIG. 7 is a logic flow diagram illustrating an exemplary sub-process or routine of FIG. 2 for receiving event information from a ticket distributor and for processing and storing information in a data store.

FIG. 8 is a logic flow diagram illustrating an exemplary sub-process or routine of FIG. 7 for receiving a business result from a business process and for processing and storing that business result in a data store.

FIG. 9 is a functional block diagram of a business processor for processing event information to derive a business result in accordance with an exemplary embodiment of the present invention.

FIG. 10 is a logic flow diagram illustrating an exemplary sub-process or routine of FIG. 2 for receiving event information from a master ticket record processor and for performing business-related processing on the event information in order to derive a business result.

FIG. 11a is a functional block diagram illustrating exemplary reporting applications for reporting event information stored in a data store.

FIG. 11b is a logic flow diagram illustrating an exemplary process or routine for retrieving event information from a data store and displaying that information to a user.

FIG. 11c is a logic flow diagram illustrating an exemplary process or routine for requesting and displaying performance metrics information about a system to a user.

FIG. 11d is a logic flow diagram illustrating an exemplary process or routine for capturing system performance metrics data and for storing the metrics data in the data store.

### DETAILED DESCRIPTION OF EXEMPLARY EMBODIMENTS

The present invention, which can be embodied in one or more program modules that run in a distributed computing environment, receives event information concerning a particular transaction from multiple data sources and processes the information as it is received so that it is available to system users for revenue recognition, information and business analysis, and reporting. Although the illustrative embodiments will be generally described in the context of the airline industry, those skilled in the art will recognize that the present invention may be implemented in any industry and for any application in which revenue is recognized at a later time after the sale of the good or service. More specifically, those skilled in the art will recognize that other exemplary embodiments of the present invention may be implemented for applications in which revenue is recognized upon the later use of the good or service and not upon the actual sale of the good or service. The travel and transportation industries are illustrative examples of such industries.

By way of example, in the airline industry, an airline recognizes revenue for the sale of a ticket only upon a passenger's use of the ticket. Thus, events that occur after the sale of the ticket by the airline may affect the amount of revenue recognized by the airline or when revenue can be recognized. The following scenarios illustrate events that may occur after the sale of a ticket and may affect the amount of revenue recognized or when revenue is recognized: (1) the passenger revises his original itinerary, which results in the payment of additional fees for the revision; (2) the passenger revises his original itinerary, which results in the payment of the difference between a less-expensive itinerary and a more-expensive itinerary; (3) the passenger is unable to fly and seeks a refund; (4) a flight or flight leg is cancelled, which results in the passenger being switched to another airline carrier; (5) the method of payment used by the passenger is invalid, and therefore the airline voids the ticket; and (6) the passenger uses the ticket. In the airline industry, such event information is typically associated with the ticket number or transaction number of the original ticket sold. Additionally, as is understood by those skilled in the art, event information may be in batch format or in real-time electronic ticketing format, where the electronic format may comprise an electronic image of a paper ticket or actual electronic ticket information.

An exemplary embodiment of the present invention can comprise an external data processor, which receives event information concerning a transaction from multiple sources via a communication link, such as via File Transfer Protocol (FTP), real-time data feeds, the Internet, or private networks. By way of example, such ticketing and event information can be received via the World Wide Web, from a global distribution system (formerly known as “airline reservation systems,” such as the “Sabre,” “Amadeus,” and “Worldspan” systems), from European and domestic ticket sales clearinghouses, and from legacy systems that store ticket and event information.

After receiving the event and ticketing information, the exemplary external data processor can format the information into a standard message format. In other words, an external data processor can receive batch event information, electronic ticket information, and electronic images of paper tickets from one or more sources and can reformat that information into a standard message format.

An exemplary ticket distributor can interact with the external data processor. The exemplary ticket distributor can receive event and ticketing information from an external data processor and can distribute the information to an exemplary master ticket record processor (hereinafter “MTR processor”). The ticket distributor can decide to which MTR processor to distribute the information based upon the ticket or transaction number associated with the event information. In other words, in one exemplary embodiment, each time event information concerning a particular transaction is received by the ticket distributor, the ticket distributor can route the information to the same MTR processor that previously handled ticketing information for that transaction.

The MTR processor can maintain ticketing and event information in a storage device, such as a data store or data mart, according to a transaction or ticket number. In other words, for each transaction, the ticketing information and event information associated with that transaction can be stored in a master ticket record in the data store. In one exemplary embodiment, as event information is received by the system, the MTR processor can update that master ticket record for that transaction. Because sometimes the same ticketing and event information can be received by the system from multiple external sources at different times, an exemplary MTR processor can use merging and data rules to decide whether the information should be stored in the master ticket record. Thus, if the information has already been received from an external data source, an MTR processor can use data rules to determine whether the newly received information should replace the previously received information. Newly received information from a particular source may be more reliable or more complete and is preferably used over information received from other data sources.

For certain predefined events, an exemplary MTR processor can publish information concerning the event to one or more subscribers via a communication link. Additionally, the MTR processor can route the event and ticketing information to one of a plurality of business processors for further business-related processing.

An exemplary business processor may comprise a workflow manager, which can receive the information from an MTR processor and which can create a work routing slip based upon the events that occurred and the content of the ticket information. The exemplary workflow manager can interface with a workflow table to determine what business services should be used to evaluate and analyze the event information.

The business processor can also comprise one or more business services, which can be used to perform the business-related processing and analysis of the event information. Examples of a business service could include a Fare Break Service, which allocates the fare data amongst the flight segments for a particular transaction, and a ProRation Service, which determines the value of each coupon used to complete a travel itinerary. Thus, the business-related processing performed by each business service can result in one or more derived business results. Additionally, as mentioned above, whether a business service will be used to process the event information can be determined by an exemplary work routing slip.

Upon the completion of the business-related processing of the information by a business service, the business service routes the information to an exemplary ticket data poster. For certain predefined events, a ticket data poster immediately routes upon the completion of a business service the event information and the derived business result to a ticket distributor for storage in the data store. The ticket data poster can also route the event information and the routing slip back to the workflow manager for further business-related processing. If the business services identified in the work routing slip have been completed, the workflow manager can route the event information and derived business results back to the ticket distributor for storage in the data store.

The exemplary embodiment of the present invention can also comprise a business services interface, which can retrieve external business reference information as needed by the MTR processors and the business processors. In other words, if an MTR processor or a business processor needs additional reference information to complete its processing of the event information, it can send a request to the business services interface to retrieve the needed information. By way of example, in order to determine the cost per leg for the flight itinerary associated with a particular transaction, a business processor may need the city name or airport information for a particular airport code contained on a ticket and the name of the airline responsible for flying that leg of the trip. The business processor could request that information from the business services interface. The business services interface can then retrieve the requested information from a plurality of external data stores in which that information is stored. More specifically, the business services interface can retrieve the airport information from a Flight Enterprise Data Store and the flight carrier information from a Schedule Enterprise Data Store.

Additionally, the exemplary embodiment also can comprise monitoring, dashboard, and reporting applications for displaying and reviewing the information contained in the data store. More specifically, an exemplary performance metrics monitor can monitor and report on the performance of each of the system components and can be used to troubleshoot the system when errors occur. Similarly, exemplary reporting applications can be used to display and summarize information stored in the data store. For example, a user may wish to display the revenue recognized on certain dates or for certain flight legs or airline carriers in order to assist in flight planning or scheduling decisions.

Using an exemplary ticket replay mechanism, a user can extract existing historical event information from the data store and re-route that information through information processing. By editing the information, the user can determine how altering a flight schedule or canceling a flight on a certain day would affect revenue. Similarly, a user can extract information from the data store and reroute that information through the business processing, so that if later business processes or new revenue recognition algorithms are added that produce new derived business data, a user can analyze old ticketing information using newly added business processes that did not exist at the time the information was originally processed. In this way, a user can take advantage of new functionality for old event information for previously occurring ticket transactions or generate supplemental revenue recognition algorithm results for previous event transactions for comparative analysis with current business algorithms.

Although the illustrative embodiments will be generally described in the context of program modules running on personal computers and servers, those skilled in the art will recognize that the present invention may be implemented in conjunction with other types of program modules for other types of computers. Additionally, those skilled in the art will recognize that the present invention may be implemented in either a stand-alone or in a distributed computing environment or both. In a distributed computing environment, program modules may be physically located in different local or remote memory storage devices. Execution of the program modules may occur locally in a stand-alone manner or remotely in a client server manner. Examples of such distributed computing environments include local area networks, Extranets, and the Internet.

The programs, processes, methods, etc. described herein are not related or limited to any particular computer or apparatus. Rather, various types of general-purpose machines may be used with the program modules constructed in accordance with the teachings described herein. Similarly, a specialized apparatus can be constructed to perform the processes and methods described herein by way of dedicated computer systems in a specific network architecture with hard-wired logic or programs stored in nonvolatile memory, such as read-only memory.

Referring now to the drawings in which like numerals represent like elements throughout the several figures, exemplary embodiments of the present invention and the illustrative operating environment will be described.

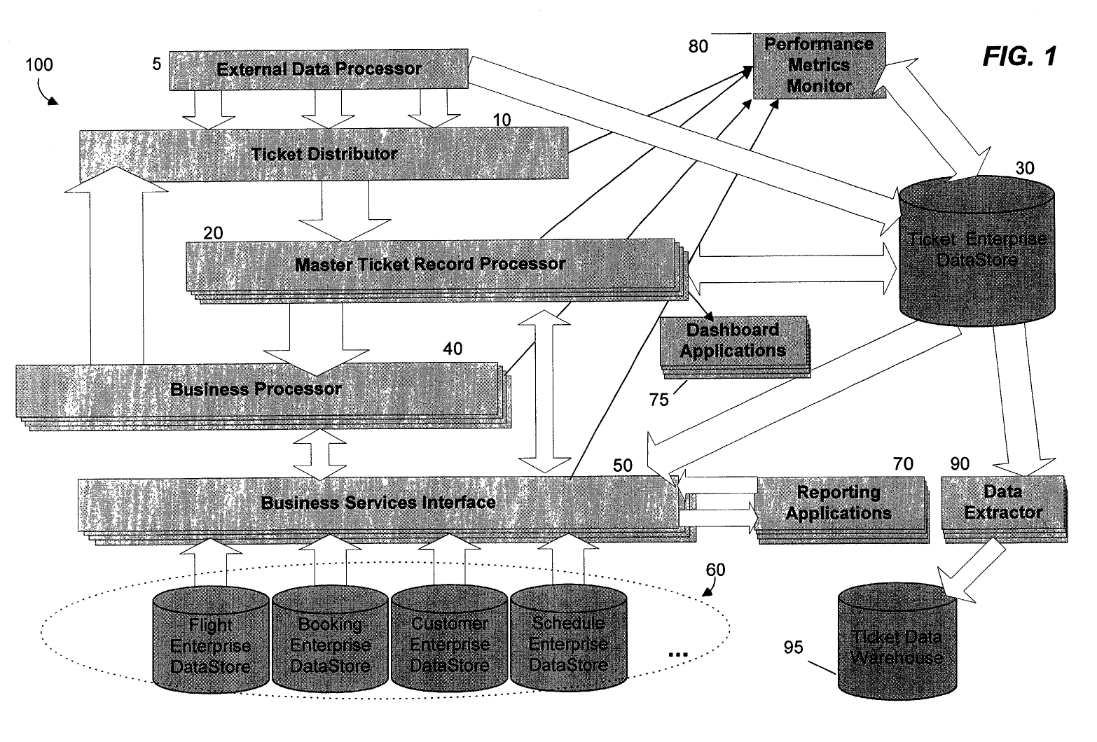

FIG. 1 illustrates exemplary components of a system 100 for processing ticketing and event information received from one or more sources. As mentioned above, the event information can be in batch or electronic format. The event information is associated with a transaction and is received upon or after each event occurs over time. More specifically, FIG. 1 illustrates a system 100 for receiving event information concerning the use of an airline ticket from multiple sources, processing the event information, and storing that information as it is received and processed. Though only individual components are illustrated in the exemplary embodiment of FIG. 1, multiple components can be employed without departing from the scope and spirit of the present invention.

The system 100 can comprise an external data processor 5, which receives the event information corresponding to a particular ticket from one or more external sources. The external data processor 5 is responsible for storing raw ticket information received from one or more sources in a storage device, such as a data store 30. Those skilled in the art will recognize that memory storage devices, such as the data store 30, can be physically located in a local or remote location and can be managed or maintained by an airline or another third party without departing from the scope and spirit of the present invention.

The external data processor 5 is also responsible for validating the information and for formatting the information into a standard format. After storing the information in a storage device, such as a data store 30, the external data processor 5 routes the event information to a ticket distributor 10 for distribution to one or more master ticket record processors (hereinafter “MTR processors”) 20. Additionally, the external data processor 5 can control when information is routed to an MTR processor 20. For example, event information can be routed by the external data processor 5 to an MTR processor 20 based upon when the information is received. Additionally, event information can be routed by the external data processor 5 to an MTR processor 20 depending on whether event information is electronic ticket information or batch ticket information. In this way, the external data processor 5 can prioritize received event information and can ensure that the most important (or most reliable) event information is processed by the system 100 first.

Upon receiving event information from the external data processor 5, the ticket distributor 10 routes that event information to one of the MTR processors 20. This MTR processor 20 processes and stores the event information in a master ticket record associated with a particular ticket in the data store 30. If needed at any time during processing, the MTR processor 20 can request external business reference information from the business services interface 50. In response to such a request, the business services interface 50 retrieves the business reference information from one of the data stores 60 where such reference information is stored. That business reference information can be routed along with the event and ticketing information in the event it is needed for later processing.

Upon the occurrence of one or more predefined events, the MTR processor 20 routes the master ticket record and the event information to one of the business processors 40 for business-related processing. More specifically, a system user may decide that performing additional business-related processing of event information for certain events is valuable in assisting the making of business decisions concerning flight scheduling or planning. For example, the system user may want the system 100 to calculate the value of each flight leg between two cities for each ticketed flight, so that he or she can later decide if that flight leg should be cancelled or if the capacity of that flight leg should be increased. Therefore, for each flight leg ticketed between those two cities (the “event”), the business processor 40 can perform that calculation and have the result stored in the master ticket record in the data store 30.

If at any time during the business-related processing of the event information additional business reference information is needed, the business processor 40 can request such information from the business services interface 50. As described above, in response to such a request, the business services interface 50 can retrieve that information from one of the data stores 60 and send that reference information back to the business processor 40.

Once the business processor 40 has completed its business-related processing of the event information, it routes the event information and the results derived during the business-related processing to the ticket distributor 10 for storage in the master ticket record corresponding to the ticket or transaction number in the data store 30. More specifically, the ticket distributor 10 routes the received event information and the results derived during the business related processing to the master ticket record processor 20 for storage in the data store 30.

In another exemplary embodiment of the present invention, the business processor 40 can receive event information for business-related processing directly from an external source. For example, the business processor 40 can receive ticket and event information from a third party airline. Upon receiving this information, the business processor 40 can request and receive business reference information from the business services interface 50, if needed, to perform the business-related processing of the information. Once the business processor 40 has completed its business-related processing of the event information, it routes the event information and the results derived during the business-related processing back to the external source from which it received the information.

The system 100 can also comprise one or more reporting applications 70, 75 and monitoring applications 80. More specifically, static reporting applications 70 and real-time dashboard applications 75 can provide business-related information and business tools to a business user to analyze current ticket transaction data and historical transaction data. By way of example only, a reporting application 70 can report and display the amount of revenue recognized to date or for a particular time period, and can report and display the amount of revenue recognized per airline or flight leg. Similarly, a dashboard application 75 can provide a real-time, instantaneous view of the amount of revenue recognized for a particular airline, flight leg, or airport.

The system 100 can also comprise one or more performance metrics monitors 80. A performance metrics monitor 80 monitors the performance of the system (and its components) and stores the data received from its analysis of the system in the data store 30. For example, a performance metrics monitor 80 may detect that information from external data sources has bottlenecked at the external data processor 5 and can alert the dashboard applications 75 that the ticket information being viewed is not current or is lagging due to the bottleneck in the system.

Further, the system 100 can also comprise a storage device, such as a ticket data warehouse 95 or data mart, for storing historical transaction-related information. More specifically, a data extractor 90 copies one or more master ticket records in the data store 30 to the ticket data warehouse 95 for long-term storage.

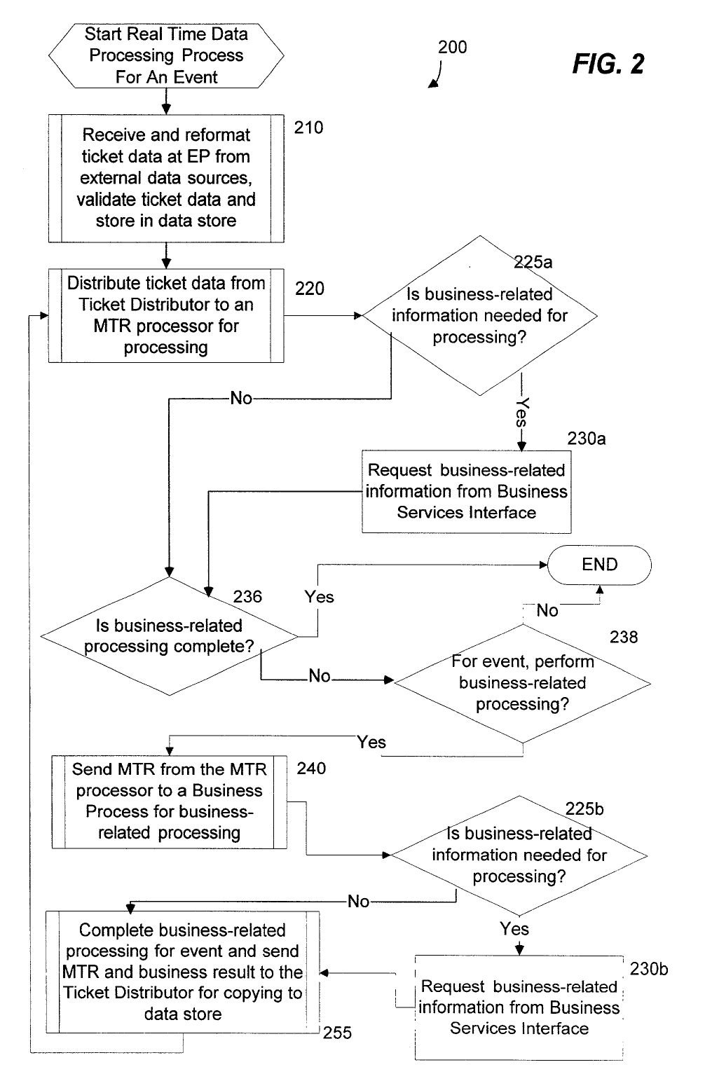

FIG. 2 illustrates an exemplary embodiment of a process 200 for processing multiple events that are associated with a single transaction and that occur over time. More specifically, FIG. 2 illustrates an exemplary process for receiving event information related to an airline ticket as each event occurs and processing and storing that information for analysis and use.

Certain steps in the processes described below in FIG. 2 through FIG. 11d must naturally precede others for the present invention to function as described. However, the present invention is not limited to the order of the steps described, if such order or sequence does not alter the functionality of the present invention. It is recognized that some steps may be performed before or after other steps without departing from the scope and the spirit of the present invention.

Step 210 is the first step in the exemplary process 200 for processing event information associated with a transaction. In Step 210, the external data processor 5 receives event information from one or more external data sources, validates the event information, reformats the information into a standard message format, and stores the event information in a data store 30. The external data processor 5 then routes the event information (in a standard message format) to the ticket distributor 10.

In Step 220, the ticket distributor 10 receives the event information from the external data processor 5 and distributes the event information to one of the MTR processors 20. The ticket distributor 10 can be configured to provide priority to certain types of data in routing that event information to an MTR processor 20. For example, the ticket distributor 10 can be set to route all electronic information received before routing any batch information to an MTR processor 20.

In Step 225a, the MTR processor 20 determines if additional business reference information is needed in order to process the received information. If additional business-related information is needed before the MTR processor 20 can complete its processing, in Step 230a the MTR processor 20 requests that business-related information from the business services interface 50. In response to this request, the business services interface 50 retrieves the requested reference information from one of the data stores 60 used to store that reference information.

In Step 236, the MTR processor 20 determines if business-related processing of the information is complete. If business-related processing is not complete, in Step 238, the MTR processor 20 determines whether business-related processing is to be performed on the event information based upon the content of the event information or the type of event that occurred. For example, the MTR processor 20 may be configured to route all event information related to a passenger's change to his or her flight itinerary for business processing.

In Step 240, upon the occurrence of one or more pre-defined events, the MTR processor 20 routes the master ticket record and the event information to one of the business processors 40 for business-related processing. In Step 225b, the business processor 40 determines if additional business-related information is needed before performing business-related processing. If additional information is needed, in Step 230b, the business processor 40 requests the business-related information from the business services interface 50. In Step 255, once the business-related processing is completed and has produced a business result, the business processor 40 routes the master ticket record and processed event information to the ticket distributor 10 for copying to the data store 30 by the MTR processor 20.

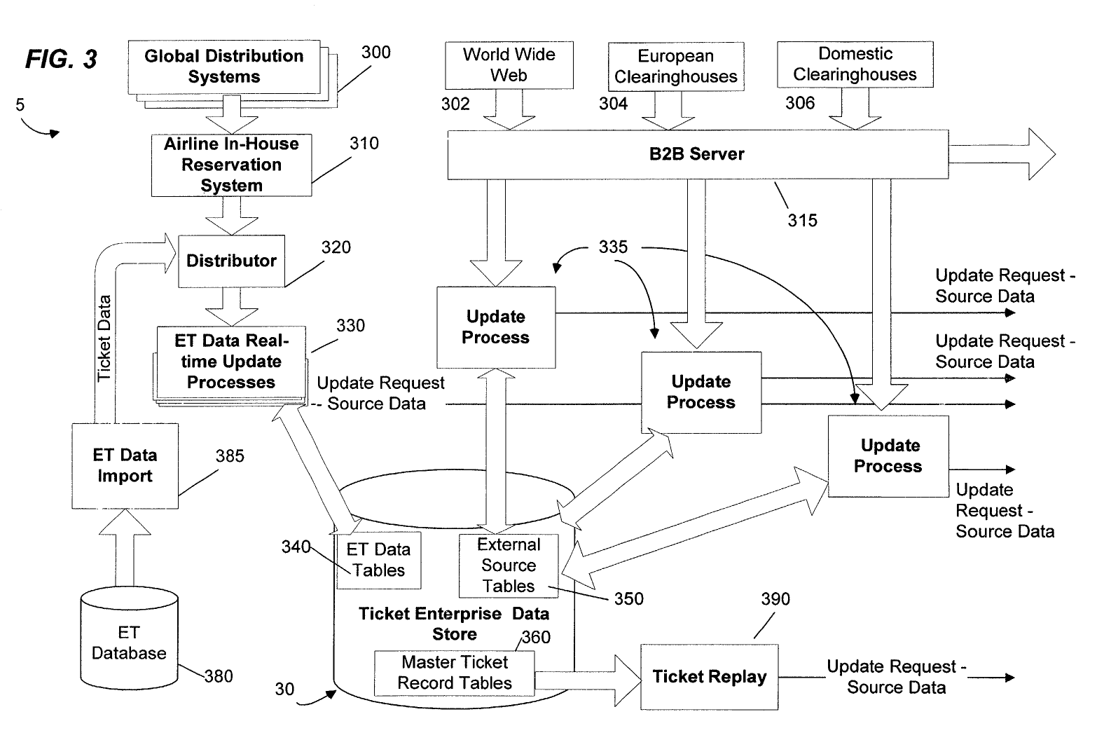

FIG. 3 illustrates an exemplary embodiment of an external data processor 5 of the present invention. The external data processor 5 receives external event information from multiple sources via a communication link. As described above, external sources of ticket information may include Web pages accessed via a global distribution system 300, such as the “Sabre,” “Amadeus,” and “Worldspan” systems, the World Wide Web 302, European and domestic ticket sales clearinghouses 304, 306, and legacy systems 380 that store ticket and event information.

In one exemplary embodiment, the external data processor 5 routes electronic ticket information from a global distribution system 300 through a reservation system 310, where the external information is made available for operational use. More specifically, the external event information concerning the changes or additions made to an existing ticket is used by the reservation system for controlling flight check-in, flight departures, boarding, gate information, and other operations. The event information is then routed to a distributor 320. The distributor 320 extracts from the received electronic information only electronic ticketing information and electronic images of paper tickets. Therefore, other electronic information such as flight schedules and boarding information is not passed on by the distributor 320 to the electronic ticket data real-time update processes 330. The distributor 320 then routes the extracted electronic ticketing information to an electronic ticket data real time update process 330, where the information is validated and then stored in an electronic data table 340 in the data store 30.

The distributor 320 can also receive information previously processed and stored by an information system in a database 380. More specifically, the distributor 320 can retrieve that previously stored information from the database 380 through a data import function 385. That information can then be validated by the update process 330 and stored in the electronic ticket data table 340 in the data store 30.

Event information from other external sources 302, 304, 306 can be routed through a server, such as the B2B server 315, and validated by an update process 335 in a similar manner. Once that external data has been validated in the update process 335, that external information is stored in an external source table 350 in the data store 30.

The external data processor 5 can also comprise a ticket replay mechanism 390. The ticket replay mechanism 390 can retrieve master ticket records stored in a master ticket record table 360 in the data store 30 and route that information to the ticket distributor 10 for what-if scenario playing. Similarly, a user can extract information from the data store 30 and reroute that information through the business processor 40, so that if later business processes are added that produce new derived business data, a user can analyze old ticket and event information using newly added business processes that did not exist at the time the information was originally processed. In this way, a user can take advantage of new functionality for old event information for previously occurring ticket transactions.

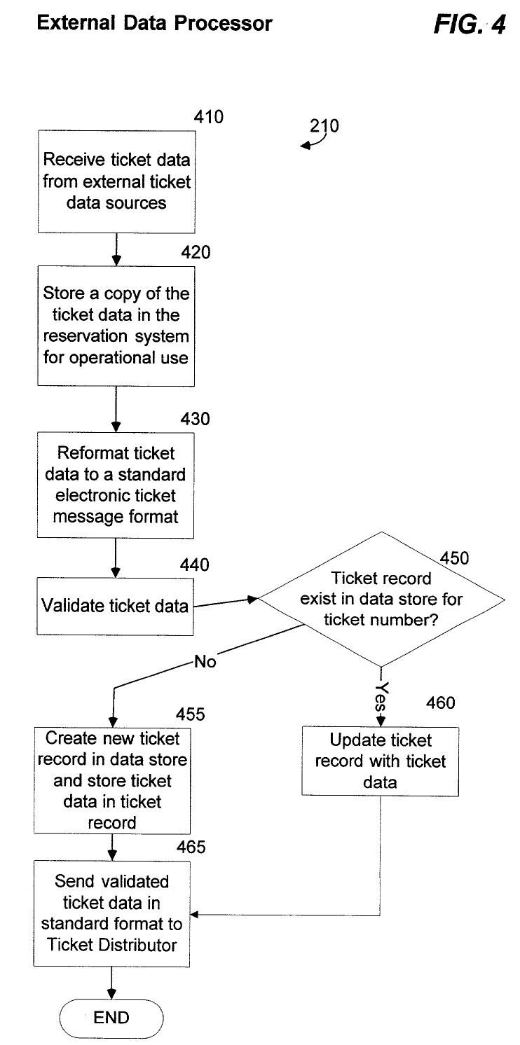

FIG. 4 is a logic flow diagram illustrating an exemplary sub-process or routine 210 of FIG. 2 for receiving event information from one or more external data sources, validating the event information, and then storing that information in a data store 30. More specifically, FIG. 4 illustrates an exemplary sub-process 210 of FIG. 2 for receiving and validating external event information and storing a copy of the event information in a data store 30.

Step 410 is the first step in the exemplary process 210 for receiving and storing external event information. In Step 410, the external data processor 5 receives ticket and event information from one or more external data sources. Typically, this information may be in batch or electronic ticketing format, or it may be an electronic image of a paper ticket.

In Step 420, the external data processor 5 stores a copy of the received event information in the reservation system 310 for operational use. More specifically, the external event information related to the changes or additions made to an existing ticket is used by the reservation system for controlling flight check-in, flight departures, boarding, gate information, and other operations.

In Step 430, the external data processor 5 reformats the event information to a standard electronic ticket message format. In Step 440, the external data processor 5 validates the received event information.

In Step 450, the external data processor 5 determines whether a ticket record exists in the data store 30 for the ticket number (or transaction number) associated with the received event information. If a ticket record does not exist in the data store 30 corresponding to the ticket or transaction number associated with the received information, in Step 455, the external data processor 5 creates a new ticket record in the data store 30 and stores the received information in the ticket record. However, in Step 450, if the external data processor 5 determines that a ticket record has already been created for that ticket number, in Step 460, the external data processor 5 updates the ticket record with the newly received information. In Step 465, the external data processor 5 then sends the validated event information in the standard format to the ticket distributor 10.

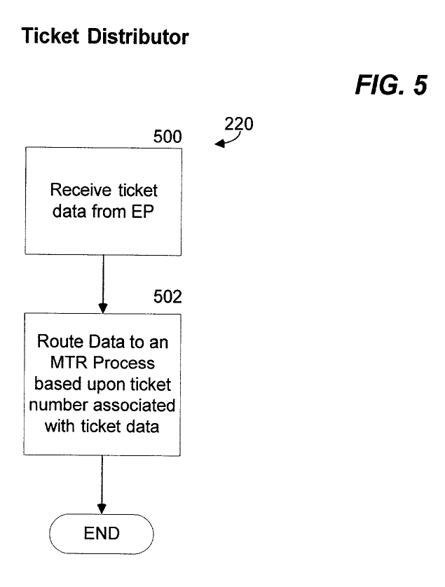

FIG. 5 illustrates an exemplary sub-process or routine 220 of FIG. 2 for receiving and distributing event information by an MTR processor 20. Step 500 is the first step in the exemplary process 220 for receiving and distributing event information. In Step 500, the ticket distributor 10 receives event information in a standard format from the external data processor 5. In Step 502, the ticket distributor 10 routes the event information to one of the MTR processors 20 according to the ticket or transaction number associated with that ticket information. If the ticket distributor 10 has previously received event information relating to that particular transaction, the ticket distributor 10 will route the newly received information to the same MTR processor 20 that previously processed the information.

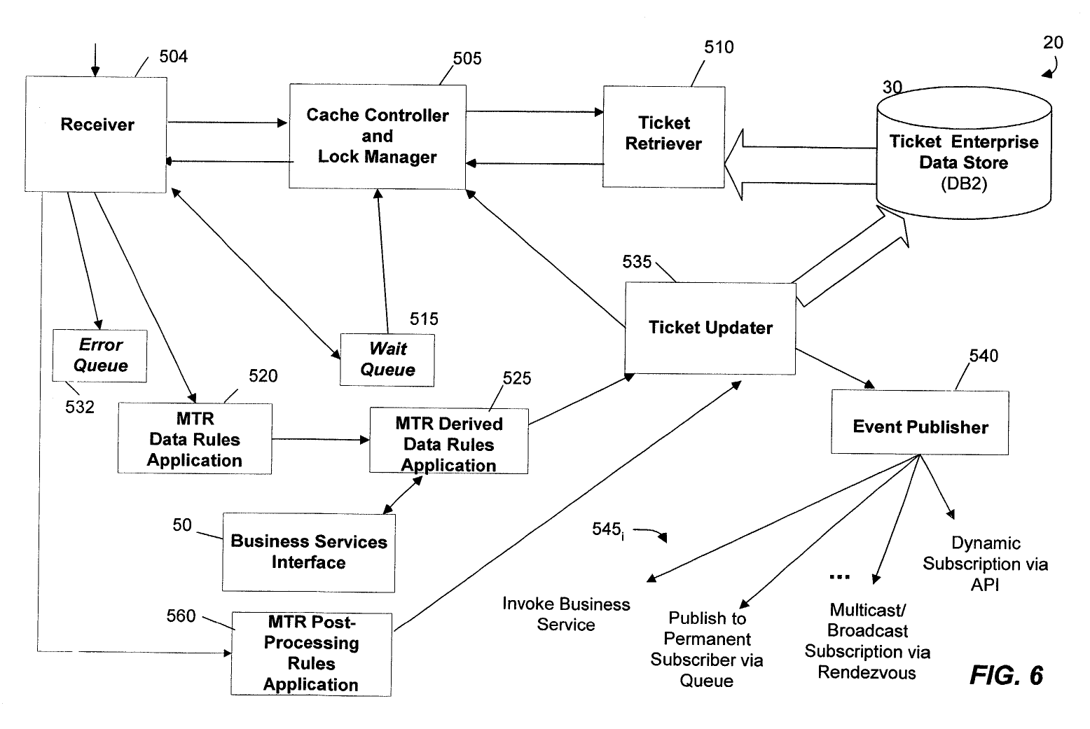

FIG. 6 illustrates an exemplary embodiment of an MTR processor 20. More specifically, FIG. 6 is a functional block diagram illustrating an exemplary MTR processor 20 for processing event information and storing the event information in a data store 30.

The MTR processor 20 can comprise a receiver 504, which receives the information from the ticket distributor 5 and retrieves the ticket number from the received information. The receiver 504 routes the received information to a cache controller and lock manager 505 (hereinafter “cache controller”). The cache controller 505 determines whether a ticket record associated with the ticket number is stored in cache. If the ticket record is not stored in cache, the cache controller 505 sends a request to the ticket retriever 510 to retrieve the master ticket record from the data store 30. Upon receiving the master ticket record from the data store 30, the ticket retriever 510 routes the master ticket record back to the cache controller 505. The cache controller 505 then stores the master ticket record in local cache.

The receiver 504 then determines whether the master ticket record is available for processing. If the master ticket record is locked, then the system is currently editing or processing information for that ticket number. Because the system cannot edit a master ticket record that is currently being edited and processed in the system, the receiver 504 places the event information in a wait queue 515 until the master ticket record is unlocked. More specifically, after a master ticket record that has been locked has been received by the receiving by the receiver 504 from the business processors 40, the information is routed to the MTR processing rules application 560. After MTR post processing rules have been applied to the master ticket record, the master ticket record is routed to a ticket updater 535. The ticket updater 535 updates the data store 30 with a new master ticket record and sends a message to the cache controller and lock manager 505. So in other words, the ticket updater 535 sends a message to the cache controller and lock manager 505 that the master ticket record can be unlocked. The cache controller and lock manager 505 unlocks the ticket and reads the wait queue 515 to determine if any other event information for this master ticket record is waiting in the wait queue 515. If event information has been received for this master ticket record, the cache controller and lock manager 505 retrieves the information from the wait queue 515 and routes the information for processing.

If the master ticket record is unlocked and if the event information received was originally received by the ticket distributor 5 from an external source, the receiver 504 routes the master ticket record and event information to a master ticket record data rules application 520. The data rules application 520 applies one or more data rules to the event information to determine how that information should be stored in the data store 30. In other words, because the same ticketing and event information may be received by the system from multiple external sources at different times, the MTR processor 20 can use merging and data rules to decide whether the information should be stored in the master ticket record. In other words, the MTR processor 20 can use data rules to determine whether newly received information from a particular source is more reliable or more complete than the same information received from other sources and therefore whether it should be used over information received from other data sources. For example, ticketing information received from clearinghouses 304, 306 is typically more complete and more detailed about the amount of taxes paid on the sales transactions than information received from other sources. Therefore, the data rules may dictate that when information is received from a clearinghouse 304, 306, that information should be written into the master ticket record, even if information concerning that event has already been received from other external data sources.

Upon completing the application of the one or more data rules, the data rules application 520 routes the information to the MTR derived data rules application 525. The MTR derived data rules application 525 is operative to augmenting the master ticket record with additional information. For example, based upon the departure and arrival city for a particular ticket, the MTR derived data rules application may calculate the distance traveled between the departure and arrival cities for use by a frequent flier program or other reporting use. The MTR derived data rules application 525 routes the ticket record to the ticket updater 535, which writes the new information to a master ticket record corresponding to the ticket or transaction number in the data store 30.

On the other hand, if the event information received by the MTR processor 20 from the ticket distributor 10 has previously been processed by a business processor 40, then the receiver 504 routes the information instead to either the MTR post-processing rules application 560 or an error queue 532. If the information received from the business processor 40 is unreadable by the receiver 504, the receiver 504 routes the information to the error queue 532. However, if the information is readable and intelligible, then the receiver 504 routes the information to the MTR post-processing rules application 560.

The MTR post-processing rules application 560 determines whether the derived business results resulting from previous business processing shall be written to the data store 30. More specifically, if a previous fare break results has been stored in the master ticket record for the same ticket number for a previously occurring event, the MTR post-processing rules application 560 determines whether the newly received business result for the current event shall be used to overwrite the previously stored information for the previous event. Upon making this determination, the MTR post-processing rules application 560 routes the information to the ticket updater 535, which updates the ticket record in the data store 30 with the new information, if the ticket record is to be updated.

Upon the occurrence of a predefined event, the ticket updater 535 also routes the information to an event publisher 540. The event publisher 540 can publish the occurrence of the event to one or more specified and pre-defined subscribers 545i or a business processor 40 via one or more communication links.

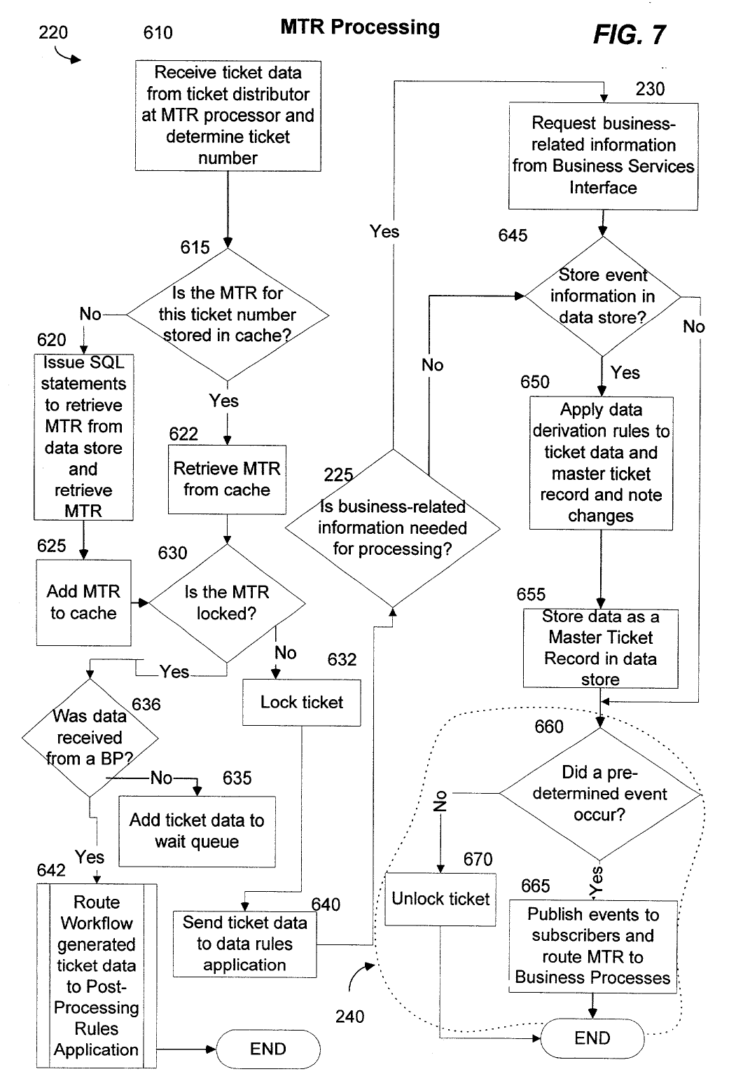

FIG. 7 illustrates an exemplary sub-process or routine 220 of FIG. 2 for receiving event information from a ticket distributor 10 and for processing that information in an MTR processor 20. Step 610 is the first step in the exemplary sub-process 220 for processing the event information. In Step 610, the MTR processor 20 receives event information from the ticket distributor 10 and determines the ticket number from the event information. In Step 615, the MTR processor 20 determines if the master ticket record associated with the ticket number is stored in cache. In Step 620, if the master ticket record is not stored in cache, the ticket retriever 510 issues SQL statements to retrieve the master ticket record from the data store 30 and executes those statements to retrieve the ticket record. In Step 625, the cache controller 505 then adds the master ticket record to cache.

On the other hand, if the master ticket record is already stored in cache in Step 615, then in Step 622, the MTR processor 20 retrieves the master ticket record from cache. In Step 630, the cache manager 505 determines if the master ticket record has been locked. If the master ticket record is locked, then in Step 636, the receiver 504 determines if the event information was received from a business processor 40 or from an external data source. If the event information was not received from a business processor 40, in Step 635, the receiver 504 adds the event information to a wait queue 515 until the master ticket record is unlocked. On the other hand, if the information was received from a business processor 40, in Step 642, the receiver 504 routes the event information and the derived business result(s) to the master ticket record post-processing rules application 560.

Referring back to Step 630, if the master ticket record is not locked, then the cache controller and lock manager 505 locks the master ticket record and routes the event information and master ticket record to the receiver 504. In, Step 640, the receiver 504 routes the event information and the master ticket record to a master ticket record data rules application 520.

In Step 225, the data rules application 520 determines if additional business-related information is needed for processing. If business-related information is needed for processing, in Step 230, the data rules application requests the business-related information from the business services interface 50.

In Step 645, the data rules application 520 applies one or more data rules to the event information and master ticket record and notes the changes. In Step 650, the MTR-derived data rules application 525 applies one or more data derivation rules to the resulting master ticket record and notes the changes. In Step 655, the ticket updater 535 stores the master ticket record and any information resulting from the applied rules in the data store 30.

In Step 660, the ticket updater 535 also determines if a predefined event occurred. If a predefined event did not occur, in Step 670, the cache controller and lock manager 505 unlocks the master ticket record because processing is complete. However, if it is determined is that a predefined event did occur, then in Step 665, the event publisher 540 publishes the event information to one or more subscribers via a communication link and routes the event information and the master ticket record to one of a plurality of business processors 40.

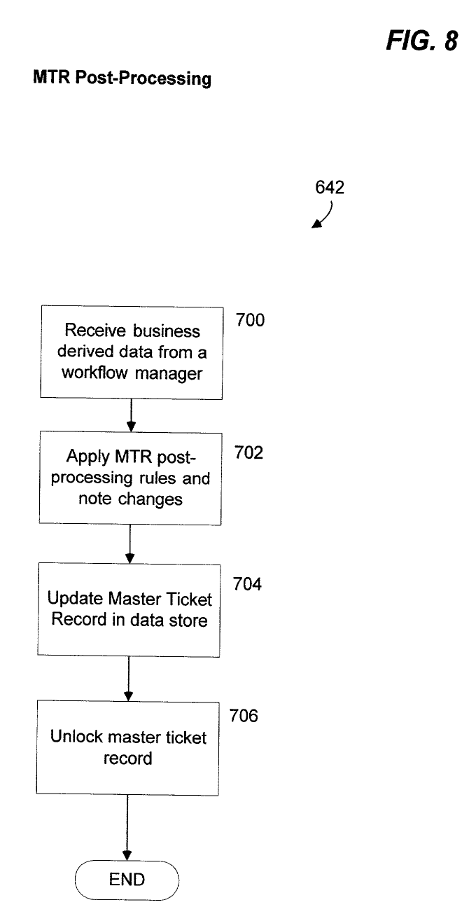

FIG. 8 illustrates an exemplary sub-process or routine 642 of FIG. 7 for updating a master ticket record in a data store 30 with event information and business results received from a business processor 40. In Step 700, the ticket distributor 10 receives event information and one or more derived business results from one of the business processors 40. The ticket distributor 10 routes the information to an MTR processor 20. In Step 702, the MTR processor 20 applies master ticket record post-processing rules and notes the changes made to the information. More specifically, if previously derived business results have already been stored in the data store 30 for the same ticket number (because a business process was performed on previously received event information), the MTR processor 20 uses post-processing rules to determine whether the previously stored business result should be overwritten with the new derived business result (or how the master ticket record should be supplemented with the event information and derived business results). In Step 704, the master ticket record updater 535 in the MTR processor 20 copies the updated information to the master ticket record corresponding to the ticket number in the data store 30. In Step 706, after updating the data store 30, the ticket updater 535 sends a message to the cache controller and lock manager 505 to unlock the master ticket record. In response, the cache controller and lock manager 505 unlocks the master ticket record.

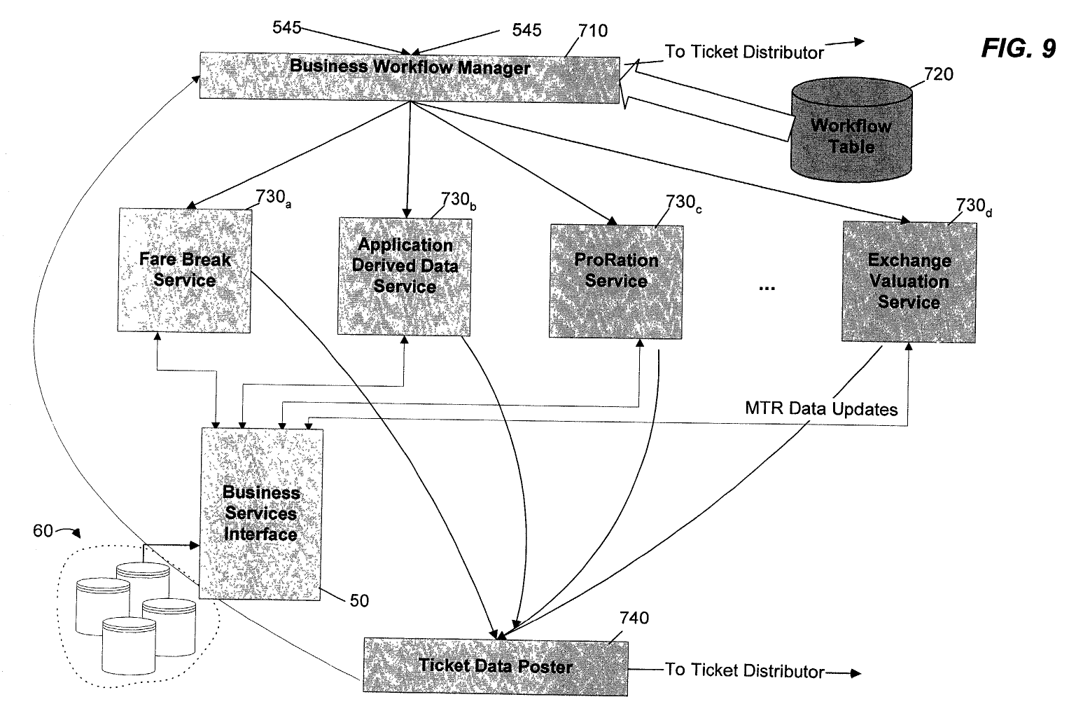

FIG. 9 is a functional block diagram of an exemplary embodiment of a business processor 40 of the present invention for processing event information to derive one or more business results. Upon the occurrence of a predefined event, an MTR processor 20 routes the master ticket record and the event information to one of the business processors 40 via a communication link 545. The business workflow manager 710 receives the information from the MTR processor 20. Based upon the information received and the type of event that occurred, the business work flow manager 710 creates a work routing slip of one or more business services 730i that shall be used to process the information. The business workflow manager 710 interfaces with a workflow table 720 to create the work routing slip. More specifically, the workflow table 720 identifies and defines which business services 730 should be used for processing certain event-related information. For example, when a coupon is used by a passenger, the workflow table 720 may require that certain business services process that event in order to accommodate that change. Because the workflow table 720 defines which business services are to be used in processing the event information and because the work routing slip is transmitted along with the event information for business related processing, business services can easily be added or modified without affecting the other system components.

Once the routing slip is created, the workflow manager 710 routes the event information, ticket record and work routing slip to the first business service 730 to be performed on the information as identified in the work routing slip. During the business service processing 730 of the information, if the business service 730 needs additional business-related information, the business service 730 can interact with the business services interface 50 to retrieve external business-related information stored in one or more business-related data stores 60. For example, in order to determine the cost per flight leg for the flight itinerary associated with a particular transaction, a business processor 40 may need the city name or airport information for a particular airport code contained on a ticket and the name of the airline responsible for flying that leg of the trip. The business processor 40 could request that information from the business services interface 50. The business services interface 50 can then retrieve the requested information from external data stores 60 in which that information is stored. More specifically, the business services interface 50 can retrieve the airport information from a Flight Enterprise Data Store and the flight carrier information from a Schedule Enterprise Data Store.

Upon the completion of a business service process 730, the derived business result and the ticket information is routed to the ticket data poster 740. The ticket data poster 740 informs the workflow manager 710 when a business service 730 has been completed and that the information can be routed on to the next business service 730 identified in the work routing slip. Additionally, upon the completion of a particular business service 730 or upon the occurrence of a particular event, the ticket data poster 740 can route the event information and the derived business result to the ticket distributor 10 for immediate processing and storage in the data store 30. For example, in one exemplary embodiment of the present invention, it may be essential that revenue recognized for a transaction on a per-flight leg basis be allocated and available to system users or subscribers as quickly and efficiently as possible. In order to accomplish that goal, each time the ProRation Service 730_{c}, which determines the value of each flight leg of a travel itinerary, completes its processing of event information and derives a ProRation business result, the ticket data poster 740 may be tasked with immediately routing the business result to the ticket distributor 10 before all of the other business services 730 identified in a work routing slip have had an opportunity to process the event information. In this way, business information derived from event information as it is processed can be made available to system users and subscribers as quickly and efficiently as possible. Additionally, business units relying on such information in order to make business-related decisions will be better equipped in making an informed decision.

In an alternative embodiment of the present invention, a third party airline or other external source of ticketing information can route a master ticket record and event information to one of the business processors 40 via a communication link. The business workflow manager 710 receives the information from the external source and creates a work routing slip of one or more business services 730i that shall be used to process the information as described above. Once the routing slip is created, the workflow manager 710 routes the event information, ticket record, and work routing slip to the first business service 730 to be performed on the information as identified in the work routing slip. Upon the completion of a business service process 730, the derived business result and the ticket information is routed to the ticket data poster 740. The ticket data poster 740 informs the workflow manager 710 when a business service 730 has been completed and that the information can be routed on to the next business service 730 identified in the work routing slip. Additionally, upon the completion of a particular business service 730 or upon the occurrence of a particular event, the ticket data poster 740 can route the event information and the derived business result back to the external source or third party airline for storage in a storage device or for additional processing.

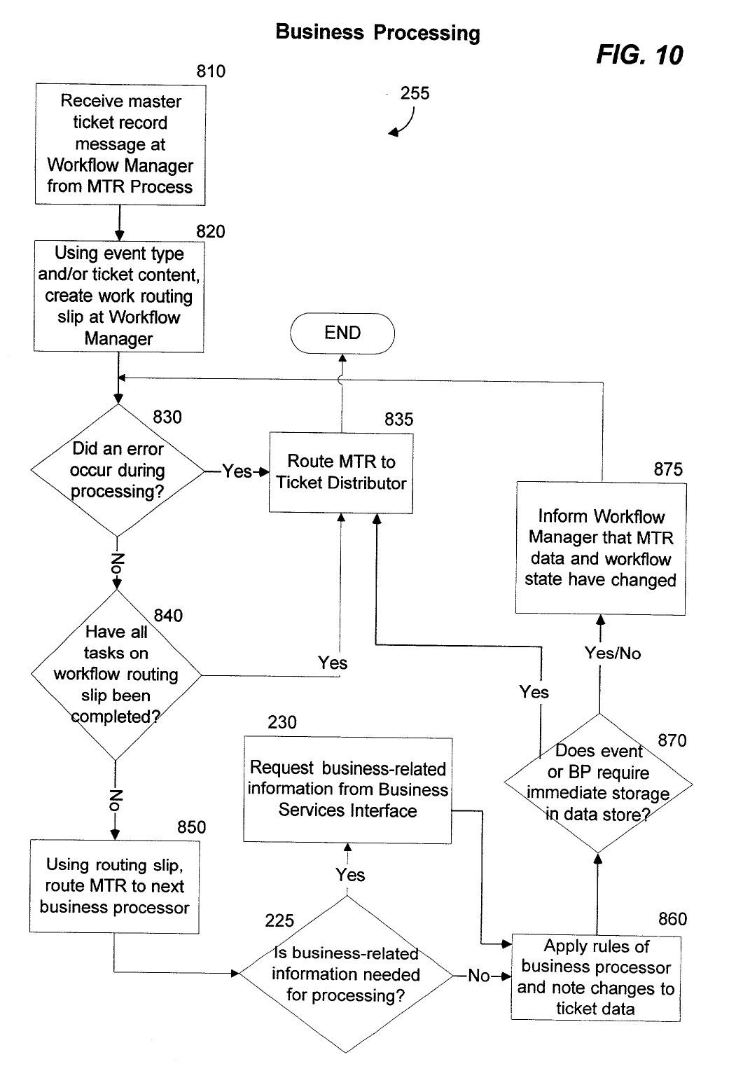

FIG. 10 is a logic flow diagram illustrating an exemplary sub-process or routine 255 of FIG. 2 for receiving event information from an MTR processor and for performing business processing on the event information in order to derive a business result. In Step 810, the workflow manager 710 receives master ticket record information from the MTR processor 20. In Step 820, based upon the event type for the ticket information and the content of the information, the workflow manager 710 interfaces with the work flow table 720 to create a work routing slip. In Step 830, the work flow manager 710 determines whether any errors have occurred during processing. If any errors have occurred during business services processing, in Step 835, the information is routed back to the ticket distributor 10 to be added to an error queue 532. Additionally, in Step 840, the workflow manager 710 reviews the work routing slip to determine if all the business services 730 identified in the work routing slip have been completed. In Step 840, if all the tasks identified in the work routing slip have been completed, the information is routed back to the ticket distributor 10 for storage in the data store 30. However, if not all of the tasks in the work routing slip have been completed, then in Step 850, the workflow manager 710 uses the work routing slip to route the master ticket record, the information, and the work routing slip to the next business service 730.

In Step 225, the business service 730 determines if any business-related information is needed during processing. In Step 230, if additional information is required, then the business service 730 interfaces with the business services interface 50 to retrieve that external reference information. However, in Step 225, if no business-related information is needed for processing, then the information is routed to Step 860, in which the business service 730 applies the rules of the business service 730 and makes any changes to the ticket information.

In Step 870, the ticket data poster 740 receives the information upon the completion of the business service 730 and determines whether a predefined event requires the immediate storage of the information in the data store 30. If immediate storage is required, then in Step 835 the ticket data poster 740 routes the information to the ticket distributor 10 for storage in the data store 30. Next, in Step 875, the ticket data poster 740 then informs the workflow manager 710 that the business service 730 has been completed and that the work routing slip can now continue to be processed.

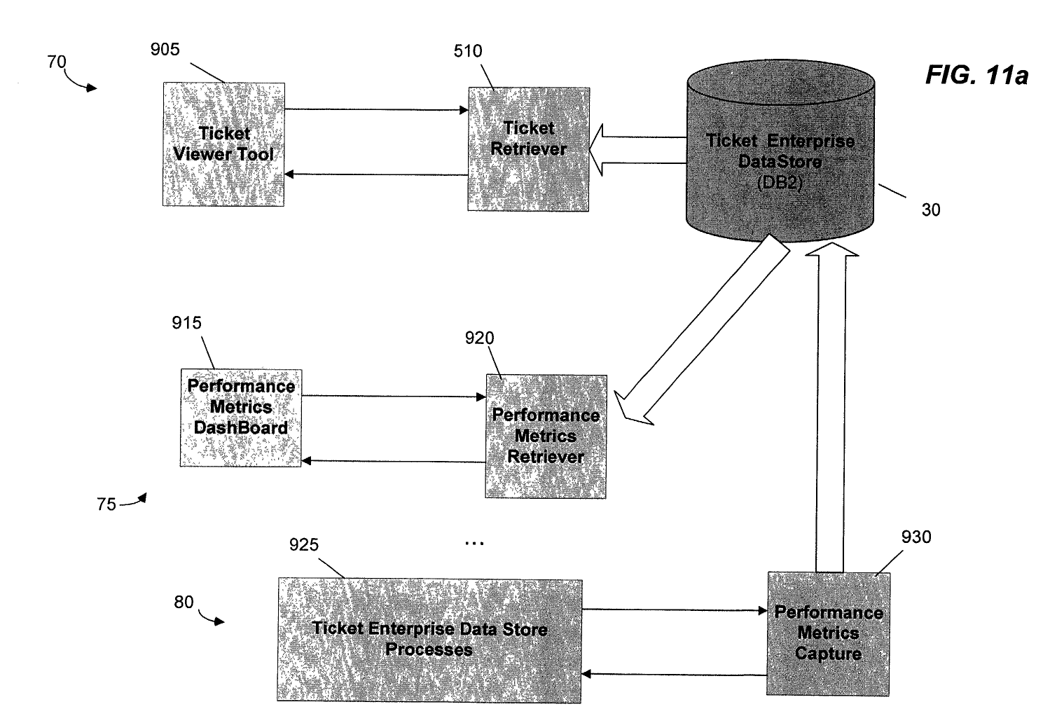

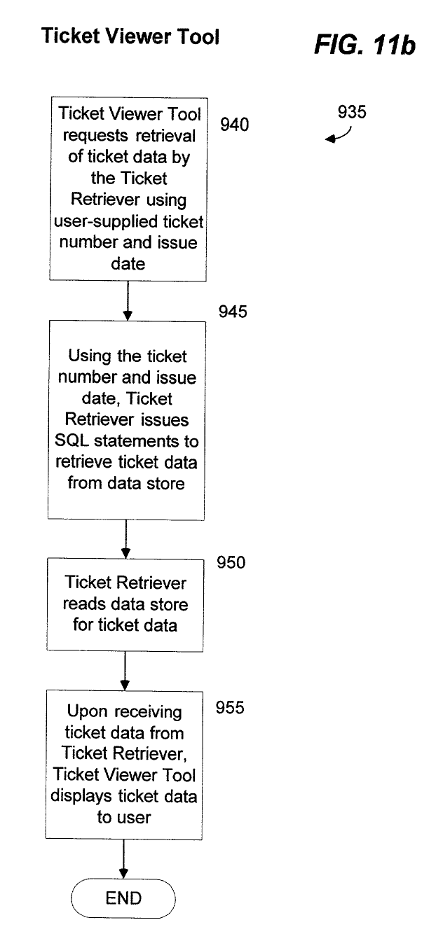

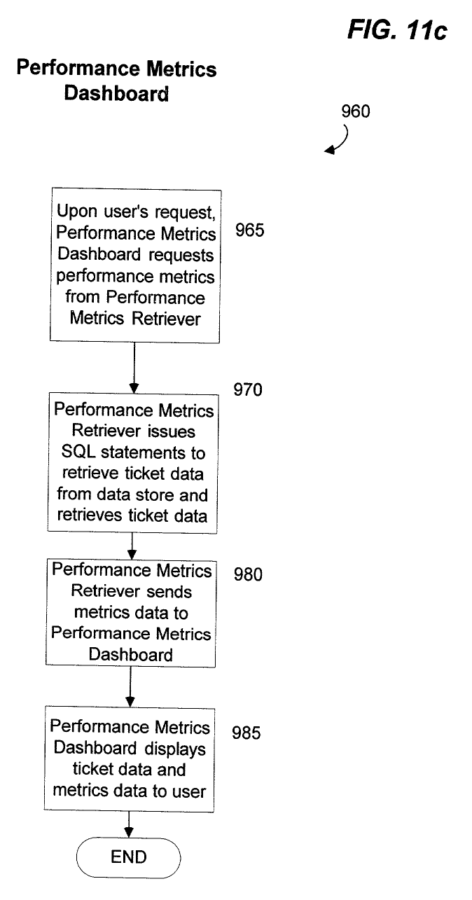

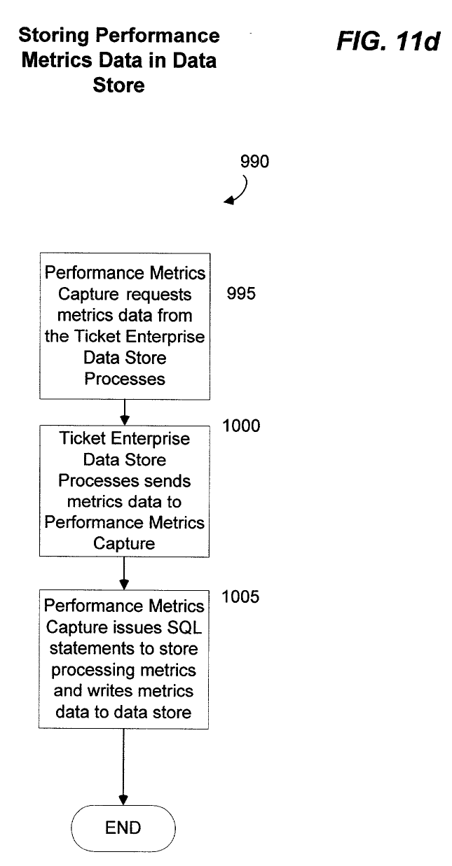

FIG. 11a illustrates an exemplary embodiment of reporting tools 70 and dashboard applications 75 of the event processing system 100. In FIG. 11a, a ticket viewer tool 905 interacts with a ticket retriever 510 to request and retrieve ticket information from the data store 30. For example, a user can use the ticket retriever 510 to view ticket information about a ticket as it was originally sold and issued to a passenger one year before. Similarly, a user can use the ticket retriever 510 to determine whether a particular flight coupon remains unused or whether a passenger has used or exchanged the flight coupon. Similarly, a performance metrics dashboard 915 interacts with a performance metrics retriever 920 to retrieve performance metrics data from a data store 30. More specifically, the performance metrics dashboard 915 can display in real time to a user performance metrics information about the revenue recognition system. For example, a performance metrics dashboard 915 can display in real time through a real time interface to the user the number of tickets processed per second, the processing time per ticket, the average ticket size in bytes of ticket information being processed by the system, and the average backlog of tickets being processed or scheduled to be processed through the system. In yet another exemplary embodiment, a business metrics dashboard can interact with a business metrics retriever to retrieve business metrics information from a data store 30. In this way, the business metrics dashboard can display to a user in real time dynamic business information. For example, the business metrics dashboard could display to a user real time revenue information for a particular type of airline fleet, for a particular geographic region, for a particular airline carrier, or for a particular flight or flight leg. Similarly, the business metrics dashboard could display information in real time concerning the number of coupons used by passengers, the number of ticket sales by a particular clearinghouse or by a particular global distribution system, and the number of tickets sold via the World Wide Web.

Finally, a ticket enterprise data store process 925 interacts with a performance metrics capture 930 to store metrics-related information in the data store 30. Once the metrics related information is stored in the data store 30, that information can later be retrieved for trend analysis. For example, a trend analysis can be performed on performance metrics information that has been stored in the data store 30 over time to determine the processing efficiencies of the revenue recognition system 100.

FIG. 11b illustrates a logic flow diagram of an exemplary sub-process or routine 935 for receiving information from a data store 30 and for displaying that information to a user. In Step 940, the ticket viewer tool 905 sends a request to the ticket retriever 510 to retrieve ticket data using a user-supplied ticket number and issue date. In Step 945, using the ticket number and issue date, the ticket retriever 510 issues SQL statements to retrieve ticket information from the data store 30. In Step 950, the ticket retriever 510 reads the data store 30 for the ticket information associated with that ticket number. In Step 955, upon receiving the ticket information from the ticket retriever 510, the ticket viewer tool 905 displays the ticket data to the user.

FIG. 11c illustrates an exemplary sub-process or routine 960 for requesting and displaying performance metrics information about the system to a user. In Step 965, upon a user's request, the performance metrics dashboard 915 requests performance metrics data from the performance metrics retriever 920. In Step 970, the performance metrics retriever 920 issues SQL statements to retrieve the ticket information from the data store 30 and retrieves such information. In Step 980, the performance metrics retriever 920 sends the metrics data to the performance metrics dashboard 915. In Step 985, the performance metrics dashboard 915 displays the ticket information and the metrics data to the user.

FIG. 11d illustrates an exemplary sub-process or routine 990 for capturing and storing system metrics-related data in a data store 30. In Step 995 a performance metrics capture 930 requests metrics data from a ticket enterprise data store process 925. In Step 1000, the ticket enterprise data store process 925 sends the metrics data to the performance metrics capture 930. The performance metrics capture 930 issues SQL statements to store processing metrics in the data store 30 and writes these metrics to the data store 30.

Those skilled in the art will appreciate that the processes and the architecture of the exemplary embodiment of the present invention can efficiently perform the real-time (and near real-time) processing of event information related to a transaction for a faster accounting for or allocation of revenue by processing event information as it is received and by augmenting a master ticket record with additional business-related information. Additionally, the system 100 can efficiently perform intermediate processing of information related to events that occur over time. Finally, the system 100 can take full advantage of the characteristics of electronic ticketing data by processing that information as it is received and by supplementing the information with results derived from further business-related processing.

It should be understood that the foregoing relates only to illustrative embodiments of the present invention, and that numerous changes may be made therein without departing from the scope and spirit of the invention as defined by the following claims.

What is claimed is:

1. A method for recognizing revenue arising from at least one transaction for services based upon the use of the services, wherein at least one transaction-related event can occur between the time of the transaction and the use of the services that can potentially affect the amount of revenue recognized for the transaction, comprising the steps of:
(a) receiving event information for a selected one of the events associated with the transaction;
(b) if business-related processing is to be performed for the selected event, performing business-related processing of the event information to generate at least one derived business result that supplements the event information;
completing steps (a) and (b) for each event of the transaction; and
recognizing revenue for the transaction in response to processing the event information for each event of the transaction.

2. The method of recognizing revenue of claim 1, further comprising determining whether the event information should be stored in a storage device, wherein the determining step comprises the steps of:
applying at least one data rule to the event information to determine if the information is to be stored in the storage device; and
if the information is to be stored in the storage device,
applying at least one data derivation rule to the event information to reach a derived result, and
storing the event information and the derived result in the storage device.

3. The method of recognizing revenue of claim 1, further comprising the step of informing at least one subscriber of the occurrence of the selected event, if the subscriber has subscribed to receive information about the selected event.

4. The method of recognizing revenue of claim 1, wherein the performing step comprises the steps of:
creating a work routing slip based upon the event information and the selected event, wherein the work routing slip defines at least one business service to be used to process the event information; and
routing the information to each business service identified in the work routing slip.

5. The method of recognizing revenue of claim 4, wherein the routing step further comprises the steps of:
for each business service identified in the work routing slip,
applying at least one rule of the business service to the event information to generate the derived business result,
retrieving business-related information if needed for performing the business-related processing,
using the retrieved business-related information to complete the business service processing, and
if specified for the business service, storing the derived business result in the storage device upon completion of the business service.

6. The method of recognizing revenue of claim 2, further comprising:
applying at least one post-processing rule to the derived business result to determine if the derived business result should be stored in the storage device; and
if the derived business result should be stored in the storage device, then storing the derived business result in the storage device.

7. A method for performing business-related processing of event information related to one of a plurality of pre-defined events upon receipt of the event information, comprising the steps of:
creating a work routing slip based upon the event information, the work routing slip defining at least one business service to be used to process the event information; and
for each business service identified by the work routing slip,
routing the event information to the business service identified by the work routing slip, and
applying at least one rule of the business service to the event information to generate at least one business result.

8. The method for performing business related processing of claim 7, wherein the applying step further comprises retrieving business-related information as needed for use by the business service.

9. The method for performing business related processing of claim 7, further comprising storing the at least one business result generated by each business service in a storage device upon completion of each business service identified by the work routing slip.

10. The method for performing business related processing of claim 9, wherein the storing step comprises the steps of:
determining whether the at least one business result should be stored in the storage device; and
if the at least one business result should be stored in the storage device, then storing the at least one business result in the storage device.

11. The method for performing business related processing of claim 7, further comprising routing the at least one business result generated by each business service to a third party for further processing of the at least one business result.

12. The method for performing business-related processing of claim 9, wherein the event information comprises historical event information extracted from the storage device.

13. A method for recognizing revenue from the sale of an airline ticket to a passenger upon the passenger's use of the airline ticket, wherein at least one event relating to the passenger's use of the ticket can occur between the time of the sale of the airline ticket and the time of the use of the airline ticket, and wherein information related to the at least one event is maintained in a storage device, comprising the steps of:
receiving information related to the event from at least one source, wherein the event is associated with the sale by a transaction identifier;
processing the information related to the event, by completing the steps of:
storing the received information related to the event and the transaction identifier in the storage device in the event that content associated with the received information is not already maintained in the storage device for the transaction identifier, and
if the content associated with the received information is maintained in the storage device for the transaction identifier, determining if the content associated with the received information maintained in the storage device should be replaced with the received information;
performing business-related processing of the received information related to the event and the information related to the at least one event that is maintained in the storage device to derive at least one business result; and
storing the at least one business result in the storage device in connection with the transaction identifier, whereby revenue is recognized for the sale of the airline ticket in response to processing the information related to the event for each event associated with the sale by the transaction identifier.

14. The method of recognizing revenue of claim 13, wherein the determining step further comprises the steps of:
applying at least one data rule to the received information to determine if the received information is to be stored in the storage device; and
if the received information is to be stored in the storage device,
applying at least one data derivation rule to the received information to derive a result that supplements the received information, and
storing the received information and the derived result in the storage device in connection with the transaction identifier.

15. The method of recognizing revenue of claim 13, wherein the storing step further comprises the step of determining whether the at least one derived business result should be stored in the storage device in connection with the transaction identifier.

16. A method for performing business-related processing of passenger usage information of an airline ticket, wherein the usage information and the airline ticket are associated with a transaction identifier, and wherein the usage information relates to an event that occurs after the sales transaction is complete and before or when the passenger uses the airline ticket, comprising the steps of:
receiving the usage information about the airline ticket, wherein the usage information comprises the transaction identifier and details about the airline ticket;
storing the transaction identifier and the received usage information in a storage device, in the event that content associated with the received usage information is not already maintained in the storage device for the transaction identifier;
if the content associated with the received usage information is maintained in the storage device for the transaction identifier, determining if the content maintained in the storage device should be replaced with the received usage information; and
if required for the event,
performing business-related processing of the received usage information and information maintained in the storage device that is associated with the transaction identifier to derive at least one business result, and
supplementing the information maintained in the storage device that is associated with the transaction identifier with the at least one derived business result.

17. A system for recognizing revenue arising from a plurality of sales transactions for services, wherein revenue is recognized at a point in time after the actual sales transaction upon the rendering of services, wherein a plurality of events can occur between the time of the sales transaction and the time of the rendering of services, and wherein the events can affect the amount of revenue recognized for a sales transaction, comprising:
a first storage device, operative to store event information received from at least one source, wherein the event information is associated with the sales transaction;
at least one master record processor, coupled to the first storage device, operative to process and store the event information; and
at least one business processor, coupled to the at least one master record processor, operative to perform business-related processing of the event information for at least one pre-defined event, each business processor further comprising a work flow manager, operative to define what business-related processing must be performed based upon the event information received by the business processor.

18. The system for processing information of claim 17, further comprising a ticket distributor, coupled to the at least one master record processor, operative to receive the event information from the at least one source and to distribute the event information to one of the master record processors.

19. The system for processing information of claim 17, further comprising a second storage device, operative to receive at least one master record from the first storage device and to store the at least one master record.
